(19) United States
(12) Patent Application Publication
(10) Pub. No.: US 2026/0193074 A1
(43) Pub. Date: Jul. 9, 2026

(54) METHOD AND FILLING INSTALLATION FOR FILLING CONTAINERS WITH A BEVERAGE

(71) Applicant: KRONES AG, Neutraubling (DE)

(72) Inventors: Michael SIEGMUND, Flensburg (DE); Georg SETZ, Lambertsneukirchen (DE); Stefan HOELLER, Thalmassing (DE); Danilo SCHULZ, Rain (DE); Johannes LEDDERER, Harrislee (DE); Alexander KAISER, Aholfing (DE)

(21) Appl. No.: 18/868,559

(22) PCT Filed: Apr. 13, 2023
(86) PCT No.: PCT/EP2023/059607

§ 371 Date: Nov. 22, 2024

(30) Foreign Application Priority Data
May 24, 2022 (DE) 10 2022 113 014.2

(51) Int. Cl. B67C 3/22; B67C 3/02

(52) U.S. Cl. CPC B67C 3/22; B67C 3/02; B67C 2003/226

(57) ABSTRACT

The invention describes a method and a filling installation for filling containers, in particular glass bottles, with a beverage, in particular beer. For this, the containers are machine-washed and consequently provided in a heated state for filling. The beverage is provided at an inlet temperature and is machine-filled at a fill temperature and then pasteurized. The containers heated thereby are cooled to an outlet temperature. Since the beverage is heated for the subsequent filling, in particular from the inlet temperature at least to the fill temperature, by means of heat obtained during cooling to the outlet temperature, the expense for cooling the hot-washed containers prior to filling can be reduced.

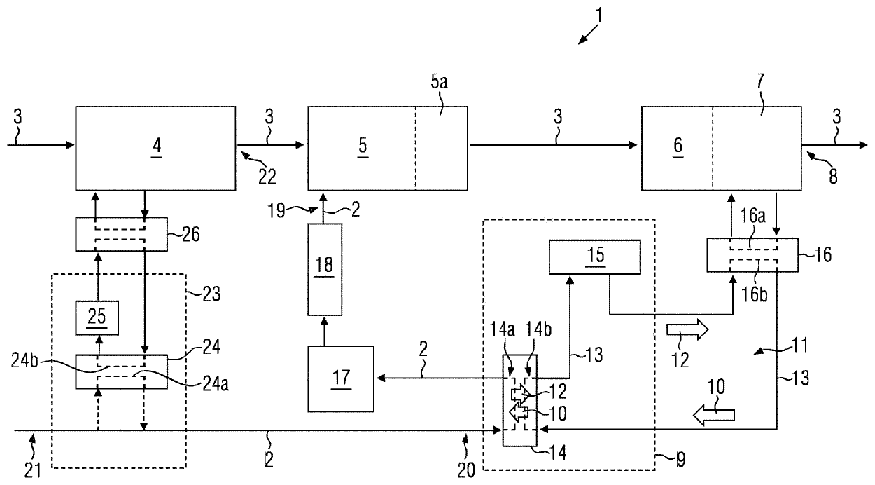

### CROSS REFERENCE TO RELATED APPLICATIONS

The present application is a U.S. National Phase of International Application No. PCT/EP2023/059607 entitled “METHOD AND FILLING INSTALLATION FOR FILLING A BEVERAGE IN CONTAINERS,” and filed on Apr. 13, 2023. International Application No. PCT/EP2023/059607 claims priority to German Patent Application No. 10 2022 113 014.2 filed on May 24, 2022. The entire contents of each of the above-listed applications are hereby incorporated by reference for all purposes.

### TECHNICAL FIELD

The invention relates to a method and a filling installation for filling containers with a beverage according to the preambles of claims 1 and 9.

### BACKGROUND AND SUMMARY

For the filling with beverages, in particular carbonated beverages or beverages mixed with other gases, such as beer, it is known to keep the beverage chilled at a storage temperature (by this is meant the buffer as a pressure tank after the fermentation cellar/filtration and before the flash fermentation/bottling, not the storage cellar) typically from 0 to 6° C. (15-20° C. for bottle fermentation) and essentially to fill glass bottles or similar containers therewith at this temperature. After sealing, they are thermally treated in a pasteurizer, wherein the corresponding inlet temperature is then also around 2 to 12° C. and an outlet temperature of the pasteurized bottles of around 25 to 40° C. is set by means of temperature-control zones. In this case, internal energy recuperation is usually carried out between inlet- and outlet-side temperature-control zones with similar temperature levels.

In most cases the containers are reusable bottles that are washed in a hot-washing machine before filling and therefore leave the machine warmed up. In order to prevent, for example, glass breakage due to a temperature difference during filling between the bottles heated in the washing machine and the product to be filled, the bottles in the washing machine on the outlet side are cooled with cold fresh water or, if necessary, by connecting them to a refrigeration machine, for example in such a way that the temperature difference between the bottles and the product to be filled is no more than approximately 20° C. This causes a high demand for fresh water and possibly, depending on the temperature of the fresh water, also active cooling by means of external cooling units.

Another disadvantage of the methods and filling installations of the type in question is that, depending on the difference between the outlet and inlet temperatures of the pasteurizer, it may be necessary to actively cool at least one temperature-control zone of the pasteurizer by supplying external cooling energy.

There is therefore a need for filling methods and filling installations that can eliminate or at least mitigate at least one of the problems mentioned above.

The stated object is achieved by a method according to claim 1 and by a filling installation according to claim 9. Preferred embodiments are specified in the dependent claims.

The method is therefore used for filling with a beverage, which is, for example, a carbonated beverage and in particular beer. The filling takes place into containers, in particular made of glass, which have been machine-washed and consequently heated before being filled.

The containers are for example bottles. In principle, the method described would also be possible with a different container type and/or with containers made of a different material, for example with rigid containers made of plastic, in particular bottles made of plastic, and is particularly advantageous with containers where there is a risk of breakage due to rapid temperature changes. Accordingly, the filling installation described is then designed to process the respective container type.

The beverage is provided to the method at an inlet temperature which may, for example, correspond to a storage temperature of the beverage, and is machine-filled at a fill temperature which, according to the invention, is higher than the inlet temperature. The storage temperature is then the temperature in a beverage buffer or pressure tank after the fermentation cellar or filtration and before short-term heating or filling, not the temperature in the storage cellar.

The containers filled with the beverage and sealed are then pasteurized and the containers hereby heated are then immediately cooled to an outlet temperature. According to the invention, the beverage is heated by means of heat obtained during cooling to the outlet temperature for the subsequent filling, in particular starting from the inlet temperature at least up to the fill temperature. This means that the beverage could, for example, be heated by 1 to 2 K above the fill temperature and cool down to the fill temperature during optional temporary storage and conveyance to filling.

Compared to a known filling method essentially at the storage temperature of the beverage, the described heating of the beverage before filling essentially to the fill temperature reduces the temperature difference with respect to the heated containers provided. In other words, the washed containers can be supplied at a higher temperature for filling than is the case with conventional methods. Accordingly, cooling energy for cooling the containers can be saved, for example by reducing the demand for fresh water.

The heat gained when the pasteurized containers are cooled to the outlet temperature is transferred to the beverage for example through a heat exchange of circulating water. Preferably, the circulating water cooled in the process is returned as cooling water to cool the pasteurized containers. This makes it possible to eliminate or at least reduce the supply of external energy for active cooling of the containers for adjusting the outlet temperature, for example by means of an active cooling unit. For this purpose, the cooling water (cooled circulating water) can be temporarily stored in a tank, in particular a cold-water tank.

The method is particularly efficient when the outlet temperature of the pasteurized containers is 1 to 15 K and in particular 2 to 12 K higher than the fill temperature.

In a particularly favorable variant of the method, the fill temperature is 20 to 40° C. and in particular 25 to 35° C. Such fill temperatures are also possible for carbonated drinks such as beer, for example with filling methods in which methods steps are carried out one after the other on containers such as bottles on a rotary type filler, as follows: raising the respective bottle to a filling valve; flushing the bottle with e.g. nitrogen, CO₂; evacuating the bottle; filling with the beverage preferably with foam compression at the filling end; closing the bottle in the same pressure chamber in which it was filled; relieving the pressure chamber; and lowering the bottle from the filling valve.

Here, the evacuated bottle can be filled without pretensioning, and the filling process can be stopped for example when in the bottle the tank pressure above the beverage is reached. The headspace of the bottles can then be filled with CO₂ (or an alternative gas). For closing, a closure can already be added to the bottle while it is being flushed, and the pressure chamber can be sealed for example by lowering a capping head from above and closing a bottle neck seal from below. Furthermore, the respective filling valve can be retracted after filling and the bottle can be closed with a crown cap.

It is possible, for example, to feed the containers, for filling, from a washing machine with an outlet temperature of at least 40° C. and in particular at least 50° C.

In the method described, conventional storage temperatures are possible as inlet temperatures, such as 0 to 20° C. and in particular 1 to 10° C.

To carry out the described method, the filling installation comprises: a washing machine for washing and consequently delivering the containers in a heated state for subsequent filling; a filler (a filling machine) for filling the containers with beverage; and a pasteurizer for pasteurizing the filled containers, wherein the pasteurizer comprises a temperature-control zone for cooling the pasteurized containers to an outlet temperature.

According to the invention, the filling installation comprises a heat exchanger unit for transferring to the beverage to be filled the heat obtained during cooling to outlet temperature.

For this purpose, the filling installation preferably comprises a water circuit for transporting heat from the temperature-control zone to the heat exchanger unit and for transporting from the heat exchanger unit to the temperature-control zone the cold extracted from the beverage during its heating. For this purpose, a cold-water tank can be integrated into the water circuit upstream of the temperature-control zone. In principle, a hot-water tank integrated downstream of the temperature-control zone would also be conceivable.

A beverage tank can be present between the heat exchanger unit and the filler, in order to store, buffer or the like the previously heated beverage until filling. A heater can be present between the beverage tank and the filler and/or between the heat exchanger unit and the filler, in order to heat the beverage to the fill temperature when the filling installation is started up, i.e. when there is not yet enough waste heat available from the pasteurizer. The heater could also be used to set a desired temperature by reheating.

It is understood that the described filling installation can have apparatus features in order to carry out described method steps and that, conversely, functions of described components of the filling installation can be used for the method.

### BRIEF DESCRIPTION OF THE FIGURES

A preferred embodiment of the invention is illustrated in the drawing. The only FIGURE shows a flow diagram of the filling installation.

### DETAILED DESCRIPTION

Accordingly, the filling installation 1 for filling containers 3, in particular bottles made of glass, with a beverage 2, which is in particular a carbonated beverage or a beverage mixed with a propellant gas (mixture) other than carbon dioxide, for example with nitrogen, such as beer, comprises a washing machine 4 for washing and consequently heating the containers 3 for subsequent filling with the beverage 2. Furthermore, the filling installation 1 comprises a filler 5 for filling the containers 3 with the beverage 2 and a pasteurizer 6 for pasteurizing the filled and closed containers 3. A pasteurization zone/temperature-control zone 7 is integrated into the pasteurizer 6 or assigned to the outlet side thereof in order to cool the pasteurized containers 3 to an outlet temperature 8.

The filling installation 1 also comprises a heat exchanger unit 9, with which heat 10 obtained when cooling the pasteurized containers 3 to the outlet temperature 8 can be transferred to the beverage 2 to be filled.

The filling installation 1 further comprises a water circuit 11 for transporting the heat 10 from the pasteurization/temperature-control zone 7 to the heat exchanger unit 9 and for transporting the cold 12 extracted from the beverage 2 during its heating there from the heat exchanger unit 9 to the temperature-control zone 7, in each case by means of circulating water 13.

For this purpose, the heat exchanger unit 9 comprises a first heat exchanger 14 with a primary circuit 14a for the beverage 2 and a secondary circuit 14b for the circulating water 13. A water tank 15, which is in particular a cold-water tank, can be integrated into the heat exchanger unit 9 or otherwise arranged in the water circuit 11 between the heat exchanger 14 and a second heat exchanger 16 assigned to the temperature-control zone 7. The second heat exchanger 16 then comprises, in a manner known in principle, a primary circuit 16a connected to the temperature-control stage 7 and a secondary circuit 16b integrated into the water circuit 11.

Between the heat exchanger unit 9 and the filler 5 there is preferably a beverage tank 17, and between these optionally also a heater 18 which can be supplied with energy independently in a manner known in principle. In the beverage tank 17, the beverage 2, which has been heated in the heat exchanger unit 9 essentially to, or slightly above, a fill temperature 19 can be temporarily stored for immediate subsequent filling. The heater 18 can be used to heat the beverage possibly to the fill temperature 19 if sufficient heat 10 (waste heat) from the temperature-control zone 7 is not yet provided in the heat exchanger unit 9, for example when starting up the filling installation 1.

The beverage 2 is provided to the heat exchanger unit 9 with an inlet temperature 20, which can for example correspond to a storage temperature 21 of the beverage 2. The inlet temperature 20 is for example 2 to 12° C.

The cleaned containers 3 leave the washing machine 4 preferably with an outlet temperature 22 of at least 40° C. and in particular of at least 50° C. The demand for cooling energy, for example from fresh water, for the outlet-side cooling of the containers 3 hot-washed in the washing machine 4 is then correspondingly low.

A difference between the inlet temperature 20 of the beverage 2 and its storage temperature 21 can result, for example, from the fact that at least one further heat exchanger unit 23 is connected upstream of the heat exchanger unit 9, with which cold is already extracted from the beverage 2 by means of a third heat exchanger 24. This would then correspondingly comprise a primary circuit 24a through which the beverage 2 flows and a secondary circuit 24b connected to at least one cold consumer. The further heat exchanger unit 24 could then be assigned its own cold-water tank 25. The washing machine 4, for example, could be considered as an associated cold consumer, which would then be connected to the secondary circuit 24b of the third heat exchanger 24 by means of a fourth heat exchanger 26 in a manner known in principle.

By means of the at least one further heat exchanger unit 24, the beverage 2 can thus be heated from the storage temperature 21 to a higher inlet temperature 20.

According to the invention, the cold energy stored in the beverage 2 can thus be used at least for cooling the pasteurization/temperature-control zone 7, but optionally also for other cold consumers in the filling installation 1, other production installations, process units, in building supply systems or for similar purposes.

At the same time, the demand for cooling the containers 3 in the outlet of the washing machine 4 decreases. For example, with a fill temperature 19 of the beverage 2 of 25 to 35° C. and an outlet temperature 22 of the container 3 from the washing machine 4 of at least 50° C., a temperature difference suitable for filling results between the beverage 2 and the container 3.

The described method can be carried out particularly efficiently if the filler 5 is designed as a combined filling-closing machine. For example, both the filling of the beverage 2 and the closing of the filled containers 3 can take place therein in the region of a pressure chamber formed on the respective filling elements (not shown). This facilitates filling at comparatively high fill temperatures 19 of, for example, 25 to 35° C. In principle, however, the filler 5 could also be assigned a downstream closing machine 5a (only indicated schematically).

1. A method for filling containers, with a beverage, wherein the containers are machine-washed and consequently provided in a heated state for subsequent filling, wherein the beverage is provided at an inlet temperature and is machine-filled at a fill temperature and then pasteurized, and the containers heated thereby are cooled to an outlet temperature, wherein the beverage is heated for the subsequent filling by means of heat obtained during cooling to the outlet temperature.

2. The method according to claim 1, wherein the heat obtained during cooling to the outlet temperature is transferred to the beverage in a heat exchanger by means of circulating water and the circulating water cooled in the process is returned as cooling water for cooling the pasteurized containers.

3. The method according to claim 2, wherein the cooling water/cooled circulating water is temporarily stored in a water tank.

4. The method according to claim 1, wherein the heated beverage is temporarily stored in a beverage tank and made available from there for filling.

5. The method according to claim 1, wherein the outlet temperature is higher than the fill temperature.

6. The method according to claim 1, wherein the containers are fed to filling from a washing machine with a discharge temperature there of at least 40° C.

7. The method according to claim 1, wherein the fill temperature is 20 to 40° C.

8. The method according to claim 1, wherein the inlet temperature is 0 to 20° C.

9. A filling installation for filling containers made of glass, with a beverage, comprising: a washing machine for washing and consequently releasing the containers in a heated state for subsequent filling; a filler for filling the containers with the beverage; and a pasteurizer for pasteurizing the filled containers, with a temperature-control zone for cooling the pasteurized containers to an outlet temperature, comprising a heat exchanger unit for transferring to the beverage to be filled heat obtained during cooling to outlet temperature.

10. The filling installation according to claim 9, further comprising a water circuit for transporting the heat from the temperature-control zone to the heat exchanger unit and for transporting from the heat exchanger unit to the temperature-control zone cold extracted from the beverage there by heat transfer.

11. The filling installation according to claim 10, further comprising a cold-water tank, integrated into the water circuit upstream of the temperature-control zone.

12. The filling installation according to claim 9, further comprising a beverage tank arranged between the heat exchanger unit and the filler for temporarily storing the heated beverage.

13. The filling installation according to claim 12, further comprising a heater arranged between the beverage tank and the filler and/or between the heat exchanger unit and the filler for additionally heating the beverage, in particular when starting up the filling installation.

14. The filling installation according to claim 9, further comprising at least one further heat exchanger unit connected upstream on the product side with an associated water circuit for transferring cold from the beverage to at least one further cold consumer.

15. The filling installation according to claim 9, wherein the filler is designed for filling at a fill temperature of the beverage of at least 15° C.

16. The method according to claim 5, wherein the outlet temperature is 2 to 12° C. higher than the fill temperature.

17. The method according to claim 6, wherein the containers are fed to filling from the washing machine with a discharge temperature there of at least 50° C.

18. The method according to claim 1, wherein the heat obtained during cooling to the outlet temperature heats the beverage for the subsequent filling from the inlet temperature at least to the fill temperature.

19. The method according to claim 8, wherein the inlet temperature is 1 to 10° C.

20. The filling installation according to claim 15, wherein the filler is designed for filling at a fill temperature of the beverage from 25 to 35° C.
